(19) United States
(12) Patent Application Publication
(10) Pub. No.: US 2007/0255022 A1
(43) Pub. Date: Nov. 1, 2007

(54) Fluorinated transition metal catalysts and formation thereof

(75) Inventors: Abbas Razavi, Mons (BE); Vladimir P. Marin, Houston, TX (US); Margarito Lopez, Pasadena, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 11/413,791

(22) Filed: Apr. 28, 2006

(51) Int. Cl. C08F 4/44; B01J 31/00

(52) U.S. Cl. 526/114; 526/901; 526/160; 526/129; 502/150; 502/152; 502/169

(57) ABSTRACT

Supported catalyst systems and methods of forming the same are generally described herein. The methods generally include providing an inorganic support composition, wherein the inorganic support composition includes a bonding sequence selected from Si—O—Al—F, F—Si—O—Al, F—Si—O—Al—F and combinations thereof and contacting the inorganic support composition with a transition metal compound to form a supported catalyst system, wherein the transition metal compound is represented by the formula [L]ₘM[A]ₙ; wherein L is a bulky ligand, A is a leaving group, M is a transition metal and m and n are such that a total ligand valency corresponds to the transition metal valency.

### FIELD

Embodiments of the present invention generally relate to supported catalyst compositions and methods of forming the same.

### BACKGROUND

Many methods of forming olefin polymers include contacting olefin monomers with transition metal catalyst systems, such as metallocene catalyst systems to form polyolefins. While it is widely recognized that the transition metal catalyst systems are capable of producing polymers having desirable properties, the transition metal catalysts generally do not experience commercially viable activities.

Therefore, a need exists to produce transition metal catalyst systems having enhanced activity.

### SUMMARY

Embodiments of the present invention include methods of forming supported catalyst systems. The methods generally include providing an inorganic support composition, wherein the inorganic support composition includes a bonding sequence selected from Si—O—Al—F, F—Si—O—Al, F—Si—O—Al—F and combinations thereof and contacting the inorganic support composition with a transition metal compound to form a supported catalyst system, wherein the transition metal compound is represented by the formula [L]ₘM[A]ₙ; wherein L is a bulky ligand, A is a leaving group, M is a transition metal and m and n are such that a total ligand valency corresponds to the transition metal valency.

Embodiments of the invention further include catalyst systems. Such catalyst systems generally include an inorganic support composition, wherein the inorganic support composition includes a bonding sequence selected from Si—O—Al—F, F—Si—O—Al, F—Si—O—Al—F and combinations thereof and an organometallic catalyst compound, wherein the transition metal compound is represented by the formula [L]ₘM[A]ₙ; wherein L is a bulky ligand, A is a leaving group, M is a transition metal and m and n are such that a total ligand valency corresponds to the transition metal valency.

### DETAILED DESCRIPTION

Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents. Further, unless otherwise specified, all compounds described herein may be substituted or unsubstituted and the listing of compounds includes derivatives thereof.

As used herein, the term “fluorinated support” refers to a support that includes fluorine or fluoride molecules (e.g., incorporated therein or on the support surface.)

The term “activity” refers to the weight of product produced per weight of the catalyst used in a process per hour of reaction at a standard set of conditions (e.g., grams product/gram catalyst/hr).

The term “olefin” refers to a hydrocarbon with a carbon-carbon double bond.

The term “substituted” refers to an atom, radical or group replacing hydrogen in a chemical compound.

The term “tacticity” refers to the arrangement of pendant groups in a polymer. For example, a polymer is “atacetic” when its pendant groups are arranged in a random fashion on both sides of the chain of the polymer. In contrast, a polymer is “isotacetic” when all of its pendant groups are arranged on the same side of the chain and “syndiotacetic” when its pendant groups alternate on opposite sides of the chain.

The term “bonding sequence” refers to an elements sequence, wherein each element is connected to another by sigma bonds, dative bonds, ionic bonds or combinations thereof.

Embodiments of the invention generally include supported catalyst compositions. The catalyst compositions generally include a support composition and a transition metal compound, which are described in greater detail below. In one or more embodiments, the support composition has a bonding sequence selected from Si—O—Al—F, F—Si—O—Al or F—Si—O—Al—F, for example.

Such catalyst compositions generally are formed by contacting a support composition with a fluorinating agent to form a fluorinated support and contacting the fluorinated support with a transition metal compound to form a supported catalyst system. As discussed in further detail below, the catalyst systems may be formed in a number of ways and sequences.

Catalyst Systems

The support composition as used herein is an aluminum containing support material. For example, the support material may include an inorganic support composition. For example, the support material may include talc, inorganic oxides, clays and clay minerals, ion-exchanged layered compounds, diatomaceous earth compounds, zeolites or a resinous support material, such as a polyolefin, for example. Specific inorganic oxides include silica, alumina, magnesia, titania and zirconia, for example.

In one or more embodiments, the support composition is an aluminum containing silica support material. In one or more embodiments, the support composition is formed of spherical particles.

The aluminum containing silica support materials may have an average particle/pore size of from about 5 microns to 100 microns, or from about 15 microns to about 30 microns, or from about 10 microns to 100 microns or from about 10 microns to about 30 microns, a surface area of from 50 m²/g to 1,000 m²/g, or from about 80 m²/g to about 800 m²/g, or from 100 m²/g to 400 m²/g, or from about 200 m²/g to about 300 m²/g or from about 150 m²/g to about 300 m²/g and a pore volume of from about 0.1 cc/g to about 5 cc/g, or from about 0.5 cc/g to about 3.5 cc/g, or from about 0.5 cc/g to about 2.0 cc/g or from about 1.0 cc/g to about 1.5 cc/g, for example.

The aluminum containing silica support materials may further have an effective number or reactive hydroxyl groups, e.g., a number that is sufficient for binding the fluorinating agent to the support material. For example, the number of reactive hydroxyl groups may be in excess of the number needed to bind the fluorinating agent to the support material is minimized. For example, the support material may include from about 0.1 mmol OH⁻/g Si to about 5 mmol OH⁻/g Si.

The aluminum containing silica support materials are generally commercially available materials, such as P10 silica alumina that is commercially available from Fuji Sylisia Chemical LTD, for example (e.g., silica alumina having a surface area of 281 m²/g and a pore volume of 1.4 ml/g.)

The aluminum containing silica support materials may further have an alumina content of from about 0.5 wt. % to about 95 wt %, of from about 0.1 wt. % to about 20 wt. %, or from about 0.1 wt. % to about 50 wt. %, or from about 1 wt. % to about 25 wt. % or from about 2 wt. % to about 8 wt. %, for example. The aluminum containing silica support materials may further have a silica to aluminum molar ratio of from about 0.01:1 to about 1000:1, for example.

Alternatively, the aluminum containing silica support materials may be formed by contacting a silica support material with a first aluminum containing compound. Such contact may occur at a reaction temperature of from about room temperature to about 150° C. The formation may further include calcining at a calcining temperature of from about 150° C. to about 600° C., or from about 200° C. to about 600° C. or from about 35° C. to about 500° C., for example.

In one embodiment, the calcining occurs in the presence of an oxygen containing compound, for example.

In one or more embodiments, the support composition is prepared by a cogel method (e.g., a gel including both silica and alumina.) As used herein, the term “cogel method” refers to a preparation process including mixing a solution including the first aluminum containing compound into a gel of silica (e.g., A12(SO₄)+H₂SO₄+Na₂O—SiO₂.)

The first aluminum containing compound may include an organic aluminum containing compound. The organic aluminum containing compound may be represented by the formula AlR₃, wherein each R is independently selected from alkyls, aryls and combinations thereof. The organic aluminum compound may include methyl alumoxane (MAO) or modified

In one or more embodiments, the molar ratio of fluorine to the first aluminum containing compound (F:Al¹) is generally from about 0.5:1 to 6:1, or from about 0.5:1 to about 4:1 or from about 2.5:1 to about 3.5:1, for example.

Embodiments of the invention generally include contacting the fluorinated support with a transition metal compound to form a supported catalyst composition. Such processes are generally known to ones skilled in the art and may include charging the transition metal compound in an inert solvent. Although the process is discussed below in terms of charging the transition metal compound in an inert solvent, the fluorinated support (either in combination with the transition metal compound or alternatively) may be mixed with the inert solvent to form a support slurry prior to contact with the transition metal compound. Methods for supporting transition metal catalysts are generally known in the art. (See, U.S. Pat. No. 5,643,847, U.S. patent No. 09184358 and 09184389, which are incorporated by reference herein.)

A variety of non-polar hydrocarbons can be used as the inert solvent, but any non-polar hydrocarbon selected should remain in liquid form at all relevant reaction temperatures and the ingredients used to form the supported catalyst composition should be at least partially soluble in the non-polar hydrocarbon. Accordingly, the non-polar hydrocarbon is considered to be a solvent herein, even though in certain embodiments the ingredients are only partially soluble in the hydrocarbon.

Suitable hydrocarbons include substituted and unsubstituted aliphatic hydrocarbons and substituted and unsubstituted aromatic hydrocarbons. For example, the inert solvent may include hexane, heptane, octane, decane, toluene, xylene, dichloromethane, chloroform, 1-chlorobutane or combinations thereof.

The transition metal compound and the fluorinated support may be contacted at a reaction temperature of from about −60° C. to about 120° C. or from about −45° C. to about 112° C. or at a reaction temperature below about 90° C., e.g., from about 0° C. to about 50° C., or from about 20° C. to about 30° C. or at room temperature, for example, for a time of from about 10 minutes to about 5 hours or from about 30 minutes to about 120 minutes, for example.

In addition, and depending on the desired degree of substitution, the weight ratio of fluorine to transition metal (F:M) is from about 1 equivalent to about 20 equivalents or from about 1 to about 5 equivalents, for example. In one embodiment, the supported catalyst composition includes from about 0.1 wt. % to about 5 wt. % transition metal compound.

Upon completion of the reaction, the solvent, along with reaction by-products, may be removed from the mixture in a conventional manner, such as by evaporation or filtering, to obtain the dry, supported catalyst composition. For example, the supported catalyst composition may be dried in the presence of magnesium sulfate. The filtrate, which contains the supported catalyst composition in high purity and yield can, without further processing, be directly used in the polymerization of olefins if the solvent is a hydrocarbon. In such a process, the fluorinated support and the transition metal compound are contacted prior to subsequent polymerization (e.g., prior to entering a reaction vessel.) Alternatively, the process may include contacting the fluorinated support with the transition metal in proximity to contact with an olefin monomer (e.g., contact within a reaction vessel.)

In one or more embodiments, the transition metal compound includes a metallocene catalyst, a late transition metal catalyst, a post metallocene catalyst or combinations thereof. Late transition metal catalysts may be characterized generally as transition metal catalysts including late transition metals, such as nickel, iron or palladium, for example. Post metallocene catalyst may be characterized generally as transition metal catalysts including Group IV, V or VI metals, for example.

Metallocene catalysts may be characterized generally as coordination compounds incorporating one or more cyclopentadienyl (Cp) groups (which may be substituted or unsubstituted, each substitution being the same or different) coordinated with a transition metal through π bonding.

The substituent groups on Cp may be linear, branched or cyclic hydrocarbyl radicals, for example. The cyclic hydrocarbyl radicals may further form other contiguous ring structures, including indenyl, azulenyl and fluorenyl groups, for example. These contiguous ring structures may also be substituted or unsubstituted by hydrocarbyl radicals, such as C₁ to C₂₀ hydrocarbyl radicals, for example.

A specific, non-limiting, example of a metallocene catalyst is a bulky ligand metallocene compound generally represented by the formula:
[L]ₘM[A]ₙ;
wherein L is a bulky ligand, A is a leaving group, M is a transition metal and m and n are such that the total ligand valency corresponds to the transition metal valency. For example m may be from 1 to 3 and n may be from 1 to 3.

The metal atom “M” of the metallocene catalyst compound, as described throughout the specification and claims, may be selected from Groups 3 through 12 atoms and lanthanide Group atoms, or from Groups 3 through 10 atoms or from Sc, Ti, Zr, Hf, V, Nb, Ta, Mn, Re, Fe, Ru, Os, Co, Rh, Ir and Ni. The oxidation state of the metal atom “M” may range from 0 to +7 or is +1, +2, +3, +4 or +5, for example.

The bulky ligand generally includes a cyclopentadienyl group (Cp) or a derivative thereof. The Cp ligand(s) form at least one chemical bond with the metal atom M to form the “metallocene catalyst.” The Cp ligands are distinct from the leaving groups bound to the catalyst compound in that they are not highly susceptible to substitution/abstraction reactions.

Cp ligands may include ring(s) or ring system(s) including atoms selected from group 13 to 16 atoms, such as carbon, nitrogen, oxygen, silicon, sulfur, phosphorous, germanium, boron, aluminum and combinations thereof, wherein carbon makes up at least 50% of the ring members. Non-limiting examples of the ring or ring systems include cyclopentadienyl, cyclopentaphenanthreneyl, indenyl, benzindenyl, fluorenyl, tetrahydroindenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, hydrogenated versions thereof (e.g., 4,5,6,7-tetrahydroindenyl or “H₄Ind”), substituted versions thereof and heterocyclic versions thereof, for example.

Cp substituent groups may include hydrogen radicals, alkyls (e.g., methyl, ethyl, propyl, butyl, pentyl, hexyl, luoromethyl, fluoroethyl, difluoroethyl, iodopropyl, bromohexyl, benzyl, phenyl, methylphenyl, tert-butylphenyl, chlorobenzyl, dimethylphosphine and methylphenylphosphine), alkenyls (e.g., 3-butenyl, 2-propenyl and 5-hexenyl), alkynyls, cycloalkyls (e.g., cyclopentyl and cyclohexyl), aryls (e.g., trimethylsilyl, trimethylgermyl, methyldiethylsilyl, acyls, aroyls, tris(trifluoromethyl)silyl, methylbis(difluoromethyl)silyl and bromomethyldimethylgermyl), alkoxys (e.g., methoxy, ethoxy, propoxy and phenoxy), aryloxys, alkylthiols, dialkylamines (e.g., dimethylamine and diphenylamine), alkylamidos, alkoxycarbonyls, aryloxycarbonyls, carbomoyls, alkyl- and dialkyl-carbamoyls, acyloxys, acylaminos, aroylaminos, organometalloid radicals (e.g., dimethylboron), Group 15 and Group 16 radicals (e.g., methylsulfide and ethylsulfide) and combinations thereof, for example. In one embodiment, at least two substituent groups, two adjacent substituent groups in one embodiment, are joined to form a ring structure.

The metal atom “M” of the metallocene catalyst compound, as described throughout the specification and claims, may be selected from Groups 3 through 12 atoms and lanthanide Group atoms, or from Groups 3 through 10 atoms or from Sc, Ti, Zr, Hf, V, Nb, Ta, Mn, Re, Fe, Ru, Os, Co, Rh, Ir and Ni. The oxidation state of the metal atom “M” may range from 0 to +7 or is +1, +2, +3, +4 or +5, for example.

The bulky ligand generally includes a cyclopentadienyl group (Cp) or a derivative thereof. The Cp ligand(s) form at least one chemical bond with the metal atom M to form the “metallocene catalyst.” The Cp ligands are distinct from the leaving groups bound to the catalyst compound in that they are not highly susceptible to substitution/abstraction reactions.

Cp ligands may include ring(s) or ring system(s) including atoms selected from group 13 to 16 atoms, such as carbon, nitrogen, oxygen, silicon, sulfur, phosphorous, germanium, boron, aluminum and combinations thereof, wherein carbon makes up at least 50% of the ring members. Non-limiting examples of the ring or ring systems include cyclopentadienyl, cyclopentaphenanthreneyl, indenyl, benzindenyl, fluorenyl, tetrahydroindenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, hydrogenated versions thereof (e.g., 4,5,6,7-tetrahydroindenyl or “H₄Ind”), substituted versions thereof and heterocyclic versions thereof, for example.

Cp substituent groups may include hydrogen radicals, alkyls (e.g., methyl, ethyl, propyl, butyl, pentyl, hexyl, luoromethyl, fluoroethyl, difluoroethyl, iodopropyl, bromohexyl, benzyl, phenyl, methylphenyl, tert-butylphenyl, chlorobenzyl, dimethylphosphine and methylphenylphosphine), alkenyls (e.g., 3-butenyl, 2-propenyl and 5-hexenyl), alkynyls, cycloalkyls (e.g, cyclopentyl and cyclohexyl), aryls (e.g., trimethylsilyl, trimethylgermyl, methyldiethylsilyl, acyls, aroyls, tris(trifluoromethyl)silyl, methylbis(difluoromethyl)silyl and bromomethyldimethylgermyl), alkoxys (e.g., methoxy, ethoxy, propoxy and phenoxy), aryloxys, alkylthiols, dialkylamines (e.g., dimethylamine and diphenylamine), alkylamidos, alkoxycarbonyls, aryloxycarbonyls, carbomoyls, alkyl- and dialkyl-carbamoyls, acyloxys, acylaminos, aroylaminos, organometalloid radicals (e.g., dimethylboron), Group 15 and Group 16 radicals (e.g., methylsulfide and ethylsulfide) and combinations thereof, for example. In one embodiment, at least two substituent groups, two adjacent substituent groups in one embodiment, are joined to form a ring structure.

Each leaving group “A” is independently selected and may include any ionic leaving group, such as halogens (e.g., chloride and fluoride), hydrides, C₁ to C₁₋₂ alkyls (e.g., methyl, ethyl, propyl, phenyl, cyclobutyl, cyclohexyl, heptyl, tolyl, trifluoromethyl, methylphenyl, dimethylphenyl and trimethylphenyl), C₂ to C₁₂ alkenyls (e.g., C₂ to C₆ fluoroalkenyls), C₆ to C₁₂ aryls (e.g., C₇ to C₂₀ alkylaryls), C₁ to C₁₂ alkoxys (e.g., phenoxy, methyoxy, ethyoxy, propoxy and benzoxy), C₆ to C₁₆ aryloxys, C₇ to C₁₈ alkylaryloxys and C₁ to C₁₂ heteroatom-containing hydrocarbons and substituted derivatives thereof, for example.

Other non-limiting examples of leaving groups include amines, phosphines, ethers, carboxylates (e.g., C₁ to C₆ alkylcarboxylates, C₆ to C₁₂ arylcarboxylates and C₇ to C₁₈ alkylarylcarboxylates), dienes, alkenes (e.g., tetramethylene, pentamethylene, methylidene), hydrocarbon radicals having from 1 to 20 carbon atoms (e.g., pentafluorophenyl) and combinations thereof, for example. In one embodiment, two or more leaving groups form a part of a fused ring or ring system.

In a specific embodiment, L and A may be bridged to one another to form a bridged metallocene catalyst. A bridged metallocene catalyst, for example, may be described by the general formula:
XCp^{A}Cp^{B}MAₙ;
wherein X is a structural bridge, Cp^{A} and Cp^{B} each denote a cyclopentadienyl group, each being the same or different and which may be either substituted or unsubstituted, M is a transition metal and A is an alkyl, hydrocarbyl or halogen group and n is an integer between 0 and 4, and either 1 or 2 in a particular embodiment.

Non-limiting examples of bridging groups “X” include divalent hydrocarbon groups containing at least one Group 13 to 16 atom, such as, but not limited to, at least one of a carbon, oxygen, nitrogen, silicon, aluminum, boron, germanium, tin and combinations thereof; wherein the heteroatom may also be a C₁ to C₁₂ alkyl or aryl group substituted to satisfy a neutral valency. The bridging group may also contain substituent groups as defined above including halogen radicals and iron. More particular non-limiting examples of bridging group are represented by C₁ to C₆ alkylenes, substituted C₁ to C₆ alkylenes, oxygen, sulfur, R₂C═, R₂Si═, —Si(R)₂Si(R₂)—, R₂Ge═ or RP═ (wherein “═” represents two chemical bonds), where R is independently selected from hydrides, hydrocarbyls, halocarbyls, hydrocarbyl-substituted organometalloids, halocarbyl-substituted organometalloids, disubstituted boron atoms, disubstituted Group 15 atoms, substituted Group 16 atoms and halogen radicals, for example. In one embodiment, the bridged metallocene catalyst component has two or more bridging groups.

Other non-limiting examples of bridging groups include methylene, ethylene, ethylidene, propylidene, isopropylidene, diphenylmethylene, 1,2-dimethylethylene, 1,2-diphenylethylene, 1,1,2,2-tetramethylethylene, dimethylsilyl, diethylsilyl, methyl-ethylsilyl, trifluoromethylbutylsilyl, bis(trifluoromethyl)silyl, di(n-butyl)silyl, di(n-propyl)silyl, di(i-propyl)silyl, di(n-hexyl)silyl, dicyclohexylsilyl, diphenylsilyl, cyclohexylphenylsilyl, t-butylcyclohexylsilyl, di(t-butylphenyl)silyl, di(p-tolyl)silyl and the corresponding moieties, wherein the Si atom is replaced by a Ge or a C atom; dimethylsilyl, diethylsilyl, dimethylgermyl and/or diethylgermyl.

In another embodiment, the bridging group may also be cyclic and include 4 to 10 ring members or 5 to 7 ring members, for example. The ring members may be selected from the elements mentioned above and/or from one or more of boron, carbon, silicon, germanium, nitrogen and oxygen, for example. Non-limiting examples of ring structures which may be present as or part of the bridging moiety are cyclobutylidene, cyclopentylidene, cyclohexylidene, cycloheptylidene, cyclooctylidene, for example. The cyclic bridging groups may be saturated or unsaturated and/or carry one or more substituents and/or be fused to one or more other ring structures. The one or more Cp groups which the above cyclic bridging moieties may optionally be fused to may be saturated or unsaturated. Moreover, these ring structures may themselves be fused, such as, for example, in the case of a naphthyl group.

In one embodiment, the metallocene catalyst includes CpFlu Type catalysts (e.g., a metallocene catalyst wherein the ligand includes a Cp fluorenyl ligand structure) represented by the following formula:
X(CpR¹ₙR²ₘ)(FlR³ₚ);
wherein Cp is a cyclopentadienyl group, Fl is a fluorenyl group, X is a structural bridge between Cp and Fl, R¹ is a substituent on the Cp, n is 1 or 2, R² is a substituent on the Cp at a position which is ortho to the bridge, m is 1 or 2, each R³ is the same or different and is a hydrocarbyl group having from 1 to 20 carbon atoms with at least one R³ being substituted in the para position on the fluorenyl group and at least one other R³ being substituted at an opposed para position on the fluorenyl group and p is 2 or 4.

In yet another aspect, the metallocene catalyst includes bridged mono-ligand metallocene compounds (e.g., mono cyclopentadienyl catalyst components). In this embodiment, the metallocene catalyst is a bridged “half-sandwich” metallocene catalyst. In yet another aspect of the invention, the at least one metallocene catalyst component is an unbridged “half sandwich” metallocene. (See, U.S. Pat. No. 6,069,213, U.S. Pat. No. 5,026,798, U.S. Pat. No. 5,703,187, U.S. Pat. No. 5,747,406, U.S. Pat. No. 5,026,798 and U.S. Pat. No. 6,069,213, which are incorporated by reference herein.)

Non-limiting examples of metallocene catalyst components consistent with the description herein include, for example:
cyclopentadienylzirconiumAₙ, indenylzirconiumAₙ, (1-methylindenyl)zirconiumAₙ, (2-methylindenyl)zirconiumAₙ, (1-propylindenyl)zirconiumAₙ, (2-propylindenyl)zirconiumAₙ, (1-butylindenyl)zirconiumAₙ, (2-butylindenyl)zirconiumAₙ, methylcyclopentadienylzirconiumAₙ, tetrahydroindenylzirconiumAₙ, pentamethylcyclopentadienylzirconiumAₙ, cyclopentadienylzirconiumAₙ, pentamethylcyclopentadienyltitaniumAₙ, tetramethylcyclopentyltitaniumAₙ, (1,2,4-trimethylcyclopentadienyl)zirconiumAₙ, dimethylsilyl(1,2,3,4-tetramethylcyclopentadienyl)(cyclopentadienyl)zirconiumAₙ, dimethylsilyl(1,2,3,4-tetramethylcyclopentadienyl)(1,2,3-trimethylcyclopentadienyl)zirconiumAₙ, dimethylsilyl(1,2,3,4-tetramethylcyclopentadienyl)(1,2-dimethylcyclopentadienyl)zirconiumAₙ, dimethylsilyl(1,2,3,4-tetramethylcyclopentadienyl)(2-methylcyclopentadienyl)zirconiumAₙ, dimethylsilylcyclopentadienylindenylzirconiumAₙ, dimethylsilyl(2-methylindenyl)(fluorenyl)zirconiumAₙ, diphenylsilyl(1,2,3,4-tetramethylcyclopentadienyl)(3-propylcyclopentadienyl)zirconiumAₙ, dimethylsilyl (1,2,3,4-tetramethylcyclopentadienyl)(3-t-butylcyclopentadienyl)zirconiumAₙ, dimethylgermyl(1,2-dimethylcyclopentadienyl)(3-isopropylcyclopentadienyl)zirconiumAₙ, dimethylsilyl(1,2,3,4-tetramethylcyclopentadienyl)(3-methylcyclopentadienyl)zirconiumAₙ, diphenylmethylidene(cyclopentadienyl)(9-fluorenyl)zirconiumAₙ, diphenylmethylidenecyclopentadienylindenylzirconiumAₙ, isopropylidenebiscyclopentadienylzirconiumAₙ, isopropylidene(cyclopentadienyl)(9-fluorenyl)zirconiumAₙ, isopropylidene(3-methylcyclopentadienyl)(9-fluorenyl)zirconiumAₙ, ethylenebis(9-fluorenyl)zirconiumAₙ, ethylenebis(1-indenyl)zirconiumAₙ, ethylenebis(1-indenyl)zirconiumAₙ, ethylenebis(2-methyl-1-indenyl)zirconiumAₙ, ethylenebis(2-methyl-4,5,6,7-tetrahydro-1-indenyl)zirconiumAₙ, ethylenebis(2-propyl-4,5,6,7-tetrahydro-1-indenyl)zirconiumAₙ, ethylenebis(2-isopropyl-4,5,6,7-tetrahydro-1-indenyl)zirconiumAₙ, ethylenebis(2-butyl-4,5,6,7-tetrahydro-1-indenyl)zirconiumAₙ, ethylenebis(2-isobutyl-4,5,6,7-tetrahydro-1-indenyl)zirconiumAₙ, dimethylsilyl(4,5,6,7-tetrahydro-1-indenyl)zirconiumAₙ, diphenyl(4,5,6,7-tetrahydro-1-indenyl)zirconiumAₙ, ethylenebis(4,5,6,7-tetrahydro-1-indenyl)zirconiumAₙ, dimethylsilylbis(cyclopentadienyl)zirconiumAₙ, dimethylsilylbis(9-fluorenyl)zirconiumAₙ, dimethylsilylbis(1-indenyl)zirconiumAₙ, dimethylsilylbis(2-methylindenyl)zirconiumAₙ, dimethylsilylbis(2-propylindenyl)zirconiumAₙ, dimethylsilylbis(2-butylindenyl)zirconiumAₙ, diphenylsilylbis(2-methylindenyl)zirconiumAₙ, diphenylsilylbis(2-propylindenyl)zirconiumAₙ, diphenylsilylbis(2-butylindenyl)zirconiumAₙ, dimethylgermylbis(2-methylindenyl)zirconiumAₙ, dimethylsilylbistetrahydroindenylzirconiumAₙ, dimethylsilylbistetramethylcyclopentadienylzirconiumAₙ, dimethylsilyl(cyclopentadienyl)(9-fluorenyl)zirconiumAₙ, diphenylsilyl(cyclopentadienyl)(9-fluorenyl)zirconiumAₙ, diphenylsilylbisindenylzirconiumAₙ, cyclotrimethylenesilyltetramethylcyclopentadienylcyclopentadienylzirconiumAₙ, cyclotetramethylenesilyltetramethylcyclopentadienylcyclopentadienylzirconiumAₙ, cyclotrimethylenesilyl(tetramethylcyclopentadienyl)(2-methylindenyl)zirconiumAₙ, cyclotrimethylenesilyl(tetramethylcyclopentadienyl)(3-methylcyclopentadienyl)zirconiumAₙ, cyclotrimethylenesilylbis(2-methylindenyl)zirconiumAₙ, cyclotrimethylenesilyl(tetramethylcyclopentadienyl)(2,3,5-trimethylclopentadienyl)zirconiumAₙ, cyclotrimethylenesilylbis(tetramethylcyclopentadienyl)zirconiumAₙ, dimethylsilyl(tetramethylcyclopentadieneyl)(N-tertbutylamido)titaniumAₙ, biscyclopentadienylchromiumAₙ, biscyclopentadienylzirconiumAₙ, bis(n-butylcyclopentadienyl)zirconiumAₙ, bis(n-dodecyclcyclopentadienyl)zirconiumAₙ, bisethylcyclopentadienylzircoriumAₙ, bisisobutylcyclopentadienylzirconiumAₙ, bisisopropylcyclopentadienylzirconiumAₙ, bismethylcyclopentadienylzirconiumAₙ, bisnoxtylcyclopentadienylzirconiumAₙ, bis(n-pentylcyclopentadienyl)zirconiumAₙ, bis(n-propylcyclopentadienyl)zirconiumAₙ, bistrimethylsilylcyclopentadienylzirconiumAₙ, bis(1,3-bis(trimethylsilyl)cyclopentadienyl)zirconiumAₙ, bis(1-ethyl-2-methylcyclopentadienyl)zirconiumAₙ, bis(1-ethyl-3-methylcyclopentadienyl)zirconiumAₙ, bispentamethylcyclopentadienylzirconiumAₙ, bispentamethylcyclopentadienylzirconiumAₙ, bis(1-propyl-3-methylcyclopentadienyl)zirconiumAₙ, bis(1-n-butyl-3-methylcyclopentadienyl)zirconiumAₙ, bis(1-isobutyl-3-methylcyclopentadienyl)zirconiumAₙ, bis(1-propyl-3-butylcyclopentadienyl)zirconiumAₙ, bis(1,3-n-butylcyclopentadienyl)zirconiumAₙ, bis(4,7-dimethylindenyl)zirconiumAₙ, bisindenylzirconiumAₙ, bis(2-methylindenyl)zirconiumAₙ, cyclopentadienylindenylzirconiumAₙ, bis(n-propylcyclopentadienyl)hafniumAₙ, bis(n-butylcyclopentadienyl)hafniumAₙ, bis(n-pentylcyclopentadienyl)hafniumAₙ, (n-propylcyclopentadienyl)(n-butylcyclopentadienyl)hafniumAₙ, bis[(2-trimethylsilylethyl)cyclopentadienyl]hafniumAₙ, bis(trimethylsilylcyclopentadienyl)hafniumAₙ, bis(2-n-propylindenyl)hafniumAₙ, bis(2-n-butylindenyl)hafniumAₙ, dimethylsilylbis(n-propylcyclopentadienyl)hafniumAₙ, dimethylsilylbis(n-butylcyclopentadienyl)hafniumAₙ, bis(9-n-propylfluorenyl)hafniumAₙ, bis(9-n-butylfluorenyl)hafniumAₙ, (9-n-propylfluorenyl)(2-n-propylindenyl)hafniumAₙ, bis(1-n-propyl-2-methylcyclopentadienyl)hafniumAₙ, (n-propylcyclopentadienyl)(1-n-propyl-3-n-butylcyclopentadienyl)hafniumAₙ, dimethylsilyltetramethylcyclopentadienylcyclopropylamidotitaniumAₙ, dimethylsilyltetramethyleyclopentadienylcyclobutylamidotitaniumAₙ, dimethylsilyltetramethyleyclopentadienylcyclopentylamidotitaniumAₙ, dimethylsilyltetramethylcyclopentadienylcyclohexylamidotitaniumAₙ, dimethylsilyltetramethylcyclopentadienylcycloheptylamidotitaniumAₙ, dimethylsilyltetramethylcyclopentadienylcyclooctylamidotitaniumAₙ, dimethylsilyltetramethylcyclopentadienylcyclononylamidotitaniumAₙ, dimethylsilyltetramethylcyclopentadienylcyclodecylamidotitaniumAₙ, dimethylsilyltetramethylcyclopentadienylcycloundecylamidotitaniumAₙ, dimethylsilyttetramethylcyclopentadienylcyclododecylamidotitaniumAₙ, dimethylsilyltetramethylcyclopentadienyl(sec-butylamido)titaniumAₙ, dimethylsilyl(tetramethylcyclopentadienyl)(n-octylamido)titaniumAₙ, dimethylsilyl(tetramethylcyclopentadienyl)(n-decylamido)titaniumAₙ, dimethylsilyl(tetramethylcyclopentadienyl)(n-octadecylamido)titaniumAₙ, methylphenylsilyltetramethylcyclopentadienylcyclopropylamidotitaniumAₙ, methylphenylsilyltetramethylcyclopentadienylcyclobutylamidotitaniumAₙ, methylphenylsilyltetramethylcyclopentadienylcyclopentylamidotitaniumAₙ, methylphenylsilyltetramethylcyclopentadienylcyclohexylamidotitaniumAₙ, methylphenylsilyltetramethylcyclopentadienylcycloheptylamidotitaniumAₙ, methylphenylsilyltetramethylcyclopentadienylcyclooctylamidotitaniumAₙ, methylphenylsilyltetramethylcyclopentadienylcyclononylamidotitaniumAₙ, methylphenylsilyltetramethylcyclopentadienylcyclodecylamidotitaniumAₙ, methylphenylsilyltetramethylcyclopentadienylcycloundecylamidotitaniumAₙ, methylphenylsilyltetramethylcyclopentadienylcyclododecylamidotitaniumAₙ, methylphenylsilyl(tetramethylcyclopentadienyl)(sec-butylamido)titaniumAₙ, methylphenylsilyl(tetramethylcyclopentadienyl)(n-octylamido)titaniumAₙ, methylphenylsilyl(tetramethylcyclopentadienyl)(n-decylamido)titaniumAₙ, methylphenylsilyl(tetramethylcyclopentadienyl)(n-octadecylamido)titaniumAₙ, diphenylsilyltetramethylcyclopentadienylcyclopropylamidotitaniumAₙ, diphenylsilyltetramethylcyclopentadienylcyclobutylamidotitaniumAₙ, diphenylsilyltetramethylcyclopentadienylcyclopentylamidotitaniumAₙ, diphenylsilyltetramethylcyclopentadienylcyclohexylamidotitaniumAₙ, diphenylsilyltetramethylcyclopentadienylcycloheptylamidotitaniumAₙ, diphenylsilyltetramethylcyclopentadienylcyclooctylamidotitaniumAₙ, diphenylsilyltetramethylcyclopentadienylcyclononylamidotitaniumAₙ, diphenylsilyltetramethylcyclopentadienylcyclodecylamidotitaniumAₙ, diphenylsilyltetramethylcyclopentadienylcycloundecylamidotitaniumAₙ, diphenylsilyltetramethylcyclopentadienylcyclododecylamidotitaniumAₙ, diphenylsilyl(tetramethylcyclopentadienyl)(sec-butylamido)titaniumAₙ, diphenylsilyl(tetramethylcyclopentadienyl)(n-octylamido)titaniumAₙ, diphenylsilyl(tetramethylcyclopentadienyl)(n-decylamido)titaniumAₙ, diphenylsilyl(tetramethylcyclopentadienyl)(n-octadecylamido)titaniumAₙ.

In one or more embodiments, the transition metal compound includes cyclopentadienyl, indenyl, fluorenyl, tetrahydroindenyl, CpFlu, alkyls, aryls, amides or combinations thereof. In one or more embodiments, the transition metal compound includes a transition metal dichloride, dimethyl or hydride. In one or more embodiments, the transition metal compound may have C₁, Cₛ or C₂ symmetry, for example. In one specific embodiment, the transition metal compound includes rac-dimethylsilanylbis(2-methyl-4-phenyl-1-indenyl)zirconium dichloride.

One or more embodiments may further include contacting the fluorinated support with a plurality of catalyst compounds (e.g., a bimetallic catalyst.) As used herein, the term “bimetallic catalyst” means any composition, mixture or system that includes at least two different catalyst compounds, each having a different metal group. Each catalyst compound may reside on a single support particle so that the bimetallic catalyst is a supported bimetallic catalyst. However, the term bimetallic catalyst also broadly includes a system or mixture in which one of the catalysts resides on one collection of support particles and another catalyst resides on another collection of support particles. The plurality of catalyst components may include any catalyst component known to one skilled in the art, so long as at least one of those catalyst components includes a transition metal compound as described herein.

As demonstrated in the examples that follow, contacting the fluorinated support with the transition metal ligand via the methods described herein unexpectedly results in a supported catalyst composition that is active without alkylation processes (e.g., contact of the catalyst component with an organometallic compound, such as MAO.)

The absence of substances, such as MAO, generally results in lower polymer production costs as alumoxanes are expensive compounds. Further, alumoxanes are generally unstable compounds that are generally stored in cold storage. However, embodiments of the present invention unexpectedly result in a catalyst composition that may be stored at room temperature for periods of time (e.g., up to 2 months) and then used directly in polymerization reactions. Such storage ability further results in improved catalyst variability as a large batch of support material may be prepared and contacted with a variety of transition metal compounds (which may be formed in small amounts optimized based on the polymer to be formed.)

In addition, it is contemplated that polymerizations absent alumoxane activators result in minimal leaching/fouling in comparison with alumoxane based systems. However, embodiments of the invention generally provide processes wherein alumoxanes may be included without detriment.

Optionally, the fluorinated support and/or the transition metal compound may be contacted with a second aluminum containing compound prior to contact with one another. In one embodiment, the fluorinated support is contacted with the second aluminum containing compound prior to contact with the transition metal compound. Alternatively, the fluorinated support may be contacted with the transition metal compound in the presence of the second aluminum containing compound.

For example, the contact may occur by contacting the fluorinated support with the second aluminum containing compound at a reaction temperature of from about 0° C. to about 150° C. or from about 20° C. to about 100° C. for a time of from about 10 minutes hour to about 5 hours or from about 30 minutes to about 120 minutes, for example.

The second aluminum containing compound may include an organic aluminum compound. The organic aluminum compound may include TEAl, TIBAl, MAO or MMAO, for example. In one embodiment, the organic aluminum compound may be represented by the formula AlR₃, wherein each R is independently selected from alkyls, aryls or combinations thereof.

In one embodiment, the weight ratio of the silica to the second aluminum containing compound (Si:Al²) is generally from about 0.01:1 to about 10:1, for example

While it has been observed that contacting the fluorinated support with the second aluminum containing compound results in a catalyst having increased activity, it is contemplated that the second aluminum containing compound may contact the transition metal compound. When the second aluminum containing compound contacts the transition metal compound, the weight ratio of the second aluminum containing compound to transition metal (Al²:M) is from about 0.1: to about 5000:1, for example.

Optionally, the fluorinated support may be contacted with one or more scavenging compounds prior to or during polymerization. The term “scavenging compounds” is meant to include those compounds effective for removing impurities (e.g., polar impurities) from the subsequent polymerization reaction environment. Impurities may be inadvertently introduced with any of the polymerization reaction components, particularly with solvent, monomer and catalyst feed, and adversely affect catalyst activity and stability. Such impurities may result in decreasing, or even elimination, of catalytic activity, for example. The polar impurities or catalyst poisons may include water, oxygen and metal impurities, for example.

The scavenging compound may include an excess of the first or second aluminum compounds described above, or may be additional known organometallic compounds, such as Group 13 organometallic compounds. For example, the scavenging compounds may include triethyl aluminum (TMA), triisobutyl aluminum (TIBAl), methylalumoxane (MAO), isobutyl aluminoxane and tri-n-octyl aluminum. In one specific embodiment, the scavenging compound is TIBAl.

In one embodiment, the amount of scavenging compound is minimized during polymerization to that amount effective to enhance activity and avoided altogether if the feeds and polymerization medium may be sufficiently free of impurities.

Polymerization Processes

As indicated elsewhere herein, catalyst systems are used to form polyolefin compositions. Once the catalyst system is prepared, as described above and/or as known to one skilled in the art, a variety of processes may be carried out using that composition. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678, U.S. Pat. No. 6,420,580, U.S. Pat. No. 6,380,328, U.S. Pat. No. 6,359,072, U.S. Pat. No. 6,346,586, U.S. Pat. No. 6,340,730, U.S. Pat. No. 6,339,134, U.S. Pat. No. 6,300,436, U.S. Pat. No. 6,274,684, U.S. Pat. No. 6,271,323, U.S. Pat. No. 6,248,845, U.S. Pat. No. 6,245,868, U.S. Pat. No. 6,245,705, U.S. Pat. No. 6,242,545, U.S. Pat. No. 6,211,105, U.S. Pat. No. 6,207,606, U.S. Pat. No. 6,180,735 and U.S. Pat. No. 6,147,173, which are incorporated by reference herein.)

In certain embodiments, the processes described above generally include polymerizing olefin monomers to form polymers. The olefin monomers may include C₂ to C₃₀ olefin monomers, or C₂ to C₁₂ olefin monomers (e.g., ethylene, propylene, butene, pentene, methylpentene, hexene, octene and decene), for example. Other monomers include ethylenically unsaturated monomers, C₄ to C₁₈ diolefins, conjugated or nonconjugated dienes, polyenes, vinyl monomers and cyclic olefins, for example. Non-limiting examples of other monomers may include norbornene, nobomadiene, isobutylene, isoprene, vinylbenzocyclobutane, sytrene, alkyl substituted styrene, ethylidene norbornene, dicyclopentadiene and cyclopentene, for example. The formed polymer may include homopolymers, copolymers or terpolymers, for example.

Examples of solution processes are described in U.S. Pat. No. 4,271,060, U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C., or from about 70° C. to about 110° C. or from about 70° C. to about 95° C., for example. (See, for example, U.S. Pat. No. 4,543,399, U.S. Pat. No. 4,588,790, U.S. Pat. No. 5,028,670, U.S. Pat. No. 5,317,036, U.S. Pat. No. 5,352,749, U.S. Pat. No. 5,405,922, U.S. Pat. No. 5,436,304, U.S. Pat. No. 5,456,471, U.S. Pat. No. 5,462,999, U.S. Pat. No. 5,616,661, U.S. Pat. No. 5,627,242, U.S. Pat. No. 5,665,818, U.S. Pat. No. 5,677,375 and U.S. Pat. No. 5,668,228, which are incorporated by reference herein.) In one embodiment, the polymerization process is a gas phase process and the transition metal compound used to form the supported catalyst composition is CpFlu.

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutene), for example. The medium employed is generally liquid under the conditions of polymerization and relatively inert. A bulk phase process is similar to that of a slurry process. However, a process may be a bulk process, a slurry process or a bulk slurry process, for example.

In a specific embodiment, a slurry process or a bulk process may be carried out continuously in one or more loop reactors. The catalyst, as slurry or as a dry free flowing powder, may be injected regularly to the reactor loop, which can itself be filled with circulating slurry of growing polymer particles in a diluent, for example. Optionally, hydrogen may be added to the process, such as for molecular weight control of the resultant polymer. The loop reactor may be maintained at a pressure of from about 27 bar to about 45 bar and a temperature of from about 38° C. to about 121° C., for example. Reaction heat may be removed through the loop wall via any method known to one skilled in the art, such as via a double-jacketed pipe.

Alternatively, other types of polymerization processes may be used, such stirred reactors in series, parallel or combinations thereof, for example. Upon removal from the reactor, the polymer may be passed to a polymer recovery system for further processing, such as addition of additives and/or extrusion, for example.

Polymer Product

The polymers (and blends thereof) formed via the processes described herein may include, but are not limited to, linear low density polyethylene, elastomers, plastomers, high density polyethylenes, low density polyethylenes, medium density polyethylenes, polypropylene (e.g., syndiotacetic, atacetic and isotacetic) and polypropylene copolymers, for example.

In one embodiment, the polymer includes syndiotacetic polypropylene. The syndiotacetic polypropylene may be formed by a supported catalyst composition including CpFlu as the transition metal compound.

In one embodiment, the polymer includes isotacetic polypropylene. The isotacetic polypropylene may be formed by a supported catalyst composition including [m] as the transition metal compound.

In one embodiment, the polymer includes a bimodal molecular weight distribution. The bimodal molecular weight distribution polymer may be formed by a supported catalyst composition including a plurality of transition metal compounds.

In one or more embodiments, the polymer has a narrow molecular weight distribution (e.g., a molecular weight distribution of from about 2 to about 4.) In another embodiment, the polymer has a broad molecular weight distribution (e.g., a molecular weight distribution of from about 4 to about 25.)

Product Application

The polymers and blends thereof are useful in applications known to one skilled in the art, such as forming operations (e.g., film, sheet, pipe and fiber extrusion and co-extrusion as well as blow molding, injection molding and rotary molding). Films include blown or cast films formed by co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include melt spinning, solution spinning and melt blown fiber operations for use in woven or non-woven form to make filters, diaper fabrics, medical garments and geotextiles, for example. Extruded articles include medical tubing, wire and cable coatings, geomembranes and pond liners, for example. Molded articles include single and multi-layered constructions in the form of bottles, tanks, large hollow articles, rigid food containers and toys, for example.

While the foregoing is directed to embodiments of the present invention, other and further embodiments of the invention may be devised without departing from the basic scope thereof and the scope thereof is determined by the claims that follow.

### EXAMPLES

In the following examples, samples of fluorinated metallocene catalyst compounds were prepared.

As used below “Silica P-10” refers to silica that was obtained from Fuji Sylisia Chemical LTD (grade: Cariact P-10, 20 μm), such silica having a surface area of 281 m²/g, a pore volume of 1.41 mL/g, an average particle size of 20.5 μm and a pH of 6.3.

As used below “SiAl(5%)” refers to silica alumina that was obtained from Fuji Sylisia Chemical LTD (Silica-Alumina 205 20 μm), such silica having a surface area of 260 m²/g, a pore volume of 1.30 mL/g, an aluminum content of 4.8 wt. %, an average particle size of 20.5 μm, a pH of 6.5 and a 0.2% loss on drying.

As used below “(NH₄)₂SiF₆” refers to ammonium hexafluorosilicate that was obtained from Aldrich Chemical Company.

As used below “DEAF” refers to diethylaluminum fluoride (26.9 wt. % in heptane) that was obtained from Akzo Nobel Polymer Chemicals, L.L.C.

As used below “MAO” refers to methylaluminoxane (30 wt. % in toluene) that was obtained from Albemarle Corporation.

Fluorinated Support A: The preparation of Fluorinated Support A was achieved by dry mixing 25.0 g of silica P10 with 0.76 g of (NH₄)₂SiF₆ and then transferring the mixture into a quartz tube having a glass-fritted disc. The quartz tube was then inserted into a tube furnace and equipped with an inverted glass fritted funnel on the top opening of the tube. The mixture was then fluidized with nitrogen (0.4 SLPM). Upon fluidization, the tube was heated from room temperature to an average reaction temperature of 116° C. over a period of 5 hours. Upon reaching the average reaction temperature, the tube was maintained at the average reaction temperature for another 4 hours. The tube was then heated to an average calcining temperature of 470° C. over 2 hours and then held at the calcining temperature for 4 hours. The tube was then removed from the heat and cooled under nitrogen. The fluorinated silica P-10 (1.0 g) was added to a glass insert that was equipped with the magnetic stirrer. The fluorinated silica was then slurried in 10 mL of toluene and stirred at ambient temperature. Slowly, 2.5 mL of MAO (30 wt. % in toluene) was added to the silica at ambient temperature. The glass inserts were then loaded to the reactor vessel. The reactor was then closed, placed on a magnetic stir plate and connected to the top manifold assembly under nitrogen. The reaction was then heated to 115° C. for 4 hours. After 4 hours, the solid was filtered through a glass filter funnel and washed once with 5 mL of toluene followed by washing 3× with 5 mL of hexane. The solid was then dried under vacuum at ambient temperature.

Fluorinated Support B: The preparation of Fluorinated Support B (middle F:Al/high Al:Si) was achieved by dry mixing 25.22 g of SiAl(5%) with 1.51 g of (NH₄)₂SiF₆ and then transferring the mixture into a quartz tube having a glass-fritted disc. The quartz tube was then inserted into a tube furnace and equipped with an inverted glass fritted funnel on the top opening of the tube. The mixture was then fluidized with nitrogen (0.4 SLPM). Upon fluidization, the tube was heated from room temperature to an average reaction temperature of 116° C. over a period of 5 hours. Upon reaching the average reaction temperature, the tube was maintained at the average reaction temperature for another 4 hours. The tube was then heated to an average calcining temperature of 470° C. over 2 hours and then held at the calcining temperature for 4 hours. The tube was then removed from the heat and cooled under nitrogen.

Fluorinated Support C: The preparation of Fluorinated Support C was achieved by transferring 50 grams of silica P-10 into a quartz glass tube (1.5“x4”) equipped with a fritted glass disc. A flow of 0.6 SLPM Nitrogen was attached to the bottom of the tube. The tube was placed in a tube furnace and the silica was heated at 150° C. for 16 hours. The silica was then collected in an Erlenmeyer flask that was equipped with a rubber tube. The rubber tube was “pinched” with a tube clip under nitrogen. The flask was then transferred into a glove box. The silica was transferred into a glass bottle and left to stand. The preparation further included weighing and transferring 20 grams of the heat treated silica P-10 (0.72 mmole OH/gram silica) into a 250 mL, 1-neck, side arm round bottom flask that was equipped with a magnetic stirrer. The silica was slurred in approximately 150 mL of toluene and stirred at room temperature. 2.36 g (0.0240 moles) of DEAF were slowly added to the slurry at room temperature and stirred for 5 minutes. The round bottom flask was equipped with a reflux condenser and heated at 50° C. for 1.0 hours. The resulting mixture was then filtered though a medium glass fritted funnel and washed 3 times each with 50 mL of hexane. The resulting solids were dried under vacuum. The preparation further included transferring 16.97 grams of the solids into the quartz glass tube and heating under a nitrogen flow of 0.6 standard liters per minute (SLPM). Upon fluidization, the tube was heated from room temperature to an average reaction temperature of 130° C. over a period of 1.0 hour. Upon reaching the temperature at 130° C., the temperature was increased to 450° C. in 1.0 hour. Once the temperature was reached to 450° C., it was held at 450° C. for 2 hours. The tube was then removed from the heat and cooled under nitrogen. The solids were collected and stored under nitrogen. The solids from part were further heat treated under the same conditions as described above except that air was used to fluidize the solids.

Comparative Support D: The preparation of Support D was achieved by transferring 25.0 g of silica P10 into a quartz tube having a glass-fritted disc. The quartz tube was then inserted into a tube furnace and equipped with an inverted glass fritted funnel on the top opening of the tube. The silica was then fluidized with nitrogen (0.4 SLPM). Upon fluidization, the tube was then heated to an average calcining temperature of 200° C. over 12 hours. The tube was then removed from the heat and cooled under nitrogen. 1.0 gram of the silica P-10 was added to a glass insert that was equipped with the magnetic stirrer. The silica was then slurried in 10 mL of toluene and stirred at ambient temperature. Slowly, 2.5 mL of MAO (30 wt. % in toluene) was added to the silica at ambient temperature. The glass inserts were then loaded to the reactor vessel. The reactor was then closed, placed on a magnetic stir plate and connected to the top manifold assembly under nitrogen. The reaction was then heated to 115° C. for 4 hours. After 4 hours, the solid was filtered through a glass filter funnel and washed once with 5 mL of toluene followed by washing 3 times with 5 mL of hexane. The solid was then dried under vacuum at ambient temperature.

Catalyst A: The preparation of Catalyst A was achieved by slurrying 0.5 grams of the support A in 5 mL of toluene at ambient temperature and stirring with a magnetic stir bar. The preparation then included adding 5 mg of rac-diemthylsilanylbis(2-methyl-4-phenyl-1-indenyl)zirconium dichloride to the fluorinated support at room temperature. The resulting mixture was then stirred for 1.0 hour. The resulting mixture was filtered through a glass filter funnel and washed once with 2 mL toluene followed by washing 3 times with 3 mL hexane. The final solids were then dried under vacuum and slurried in mineral oil.

Catalyst B: The preparation of Catalyst B was achieved by slurrying 1.01 g of Fluorinated Support B in 6 mL of toluene and stirring with a magnetic stir bar. The preparation then included adding 4.0 g of TIBAl (25.2 wt. % in heptane) to the mixture and the mixture was then stirred for about 5 minutes at room temperature. The preparation then included adding 22.7 mg of rac-dimethylsilanylbis(2-methyl-4-phenyl-1-indenyl)zirconium dichloride to the fluorinated support at room temperature. The resulting mixture was then stirred for 2 hours at room temperature. The resulting mixture was then filtered through a medium glass filter funnel and washed two times with 5 mL of hexane. The final solids were then dried under vacuum and slurried in 12.3 g of mineral oil.

Catalyst C: The preparation of Catalyst C was achieved by slurrying 1.03 g of Fluorinated Support C in 6 mL of toluene and stirring with a magnetic stir bar. The preparation then included adding 4.01 g of TIBAl (25.2 wt. % in heptane) to the mixture and the mixture was then stirred for about 5 minutes at room temperature. The preparation then included adding 20.0 mg of rac-dimethylsilanylbis(2-methyl-4-phenyl-1-indenyl)zirconium dichloride to the fluorinated support at room temperature. The resulting mixture was then stirred for 1.5 hours at room temperature. The resulting mixture was then filtered through a medium glass filter funnel and washed once with 5 mL toluene followed by washing once with 5 mL hexane. After drying at ambient temperature for about 1 hour, the solids were slurried in dry mineral oil. The final solids were then dried under vacuum and slurried in mineral oil.

Catalyst D: The preparation of Catalyst D was achieved by slurrying 0.5 grams of the support D in 5 mL of toluene at ambient temperature and stirring with a magnetic stir bar. The preparation then included adding 5 mg of rac-diemthylsilanylbis(2-methyl-4-phenyl-1-indenyl)zirconium dichloride to the fluorinated support at room temperature. The resulting mixture was then stirred for 1.0 hour. The resulting mixture was filtered through a glass filter funnel and washed once with 2 mL toluene followed by washing 3 times with 3 mL hexane. The final solids were then dried under vacuum and slurried in mineral oil.

The resulting catalysts were then exposed to polymerization with olefin monomer to form the resulting polymer. The results of such polymerizations follow in Tables 1 and 2, respectively.

TABLE 1
(Polypropylene)

| Cata- | Co- | | | | | | | |
|---|---|---|---|---|---|---|---|---|
| lyst | Catalyst | Activity | M | T_{R} | T_{M2} | Mw | Mw/Mn | Mz/Mw |
| D | TEAL | 10786 | 1 | 107.6 | 149.0 | 200199 | 5.2 | 3.3 |
| A | TEAL | 12508 | 1 | 107.6 | 149.4 | 211691 | 3.7 | 2.7 |
| B | TEAL | 1334 | 2 | 108.0 | 148.7 | 105258 | 5.2 | 2.3 |
| B | TIBAL | 5272 | 2 | 107.1 | 149.4 | 200708 | 4.8 | 2.6 |
| C | TEAL | 405 | 2 | 109.5 | 149.9 | 119610 | 5.6 | 2.3 |
| C | TIBAL | 5849 | 2 | 108.0 | 149.7 | 174815 | 4.7 | 2.7 |

*t is polymerization time in minutes, activity is expressed in gPP/gCat/hour, M is the catalyst loading in wt. %, T_{R} is recrystallization temperature in ° C., T_{M2} is the temperature of the second melt peak in ° C.

TABLE 2
(Polyethylene)

| | Co- | | | | | | | | | |
|---|---|---|---|---|---|---|---|---|---|---|
| Catalyst | Catlyst | t | Activity | M | T_{R} | T_{M2} | Mn | Mw | Mz | HLMI |
| B | TIBAL | 60 | 1903 | 2 | 94.6 | 103.7 | 29730 | 201841 | 590085 | 0.3 |
| E | TIBAL | 60 | 5151 | 2 | 111.0 | 128.0 | 23807 | 216617 | 618982 | 1.7 |

*t is polymerization time in minutes, activity is expressed in gPP/gCat/hour, M is the catalyst loading in wt. %, T_{R} is recrystallization temperature in ° C., T_{M2} is the temperature of the second melt peak in ° C., HLMI is explessed in g/10 min., Catalyst E is composed of the metallocene rac-Ethylenebis(tetrahydroindenyl)ZrCl2 supported on MAO/SiO2 support.

Unexpectedly, it has been discovered that the productivity of polyolefin polymerizations can be controlled by the catalyst preparation methods described herein.

As demonstrated in the examples above, a higher (5 wt. %) Al¹:Si ratio results in higher catalyst activity than the lower (1 wt. %) Al¹:Si molar ratio. (See, Catalysts E and C.)

Further, it has been demonstrated that F:Al¹ molar ratios of about 3:1 result in higher catalyst activities than ratios of 6:1 or 2:1. (See, Catalysts B, C and D.) It has also been observed that transition metal loadings of 2 wt. % result in higher catalyst activities than loadings of 1 wt. %. (See, Catalysts B and C.)

In addition, it was unexpectedly observed that when the scavenger was added to the fluorinated support prior to contact with the transition metal compound, higher catalyst activities were observed than when the transition metal compound is contacted with the scavenging compound. (See, Catalysts A and B.)

What is claimed is:

1. A method comprising:
providing an inorganic support composition, wherein the inorganic support composition comprises a bonding sequence selected from Si—O—Al—F, F—Si—O—Al, F—Si—O—Al—F and combinations thereof; and
contacting the inorganic support composition with a transition metal compound to form a supported catalyst system, wherein the transition metal compound is represented by the formula [L]ₘM[A]ₙ; wherein L is a bulky ligand, A is a leaving group, M is a transition metal and m and n are such that a total ligand valency corresponds to the transition metal valency.

2. The method of claim 1, wherein the inorganic support composition is formed by simultaneously forming SiO₂ and Al₂O₃ and contacting the SiO₂ and Al₂O₃ with a fluorinating agent.

3. The method of claim 1, wherein the inorganic support composition is formed by contacting a silica containing compound with a fluorinating agent and then with an organic aluminum containing compound, wherein the organic aluminum containing compound is represented by the formula AlR₃ and wherein each R is independently selected from alkyls, aryls and combinations thereof.

4. The method of claim 1, wherein the inorganic support composition is formed by contacting a silica containing compound with an aluminum containing compound and then with a fluorinating agent, wherein the organic aluminum containing compound is represented by the formula AlR₃ and where each R is independently selected from alkyls, aryls and combinations thereof.

5. The method of claim 1, wherein the inorganic support composition is formed by providing an alumina-silica support and contacting the alumina-silica support with a fluorinating agent.

6. The method of claim 1, wherein the inorganic support composition is formed by providing a silica support and contacting the silica support with a fluorinating agent represented by the formula RₙAlF₃₋ₙ, wherein each R is independently selected from alkyls, aryls and combinations thereof and n is 1 or 2.

7. The method of claim 1, wherein the inorganic support composition is contacted with the transition metal compound in the presence of a second aluminum containing compound represented by the formula AlR₃, wherein each R is independently selected from alkyls, alkoxys, aryls, aryloxys, halogens or combinations thereof.

8. The method of claim 7, wherein the second aluminum containing compound comprises triisobutylaluminum.

9. The method of claim 1, wherein the supported catalyst composition comprises a weight ratio of silica to aluminum (Al¹) of from about 0.01:1 to about 1000:1 and a weight ratio of fluorine to silica of from about 0.001:1 to about 0.3:1.

10. The method of claim 1, wherein the supported catalyst composition comprises a molar ratio of fluorine to silica of about 1:1.

11. The method of claim 1, wherein the supported catalyst composition comprises from about 0.1 wt. % to about 5 wt. % transition metal compound.

12. The method of claim 1, wherein the supported catalyst composition is active for polymerization absent alkylation.

13. The method of claim 1 further comprising storing the supported catalyst system for a period of time prior to contact with an olefin monomer.

14. The method of claim 1, wherein the contact of the inorganic support composition and the transition metal compound occurs in proximity to contact with an olefin monomer.

15. The method of claim 1, wherein the inorganic support composition is contacted with a plurality of transition metal compounds.

16. The method of claim 15 further comprising contacting the supported catalyst system with an olefin monomer to form a polyolefin, wherein the polyolefin has a bimodal molecular weight distribution.

17. A supported metallocene catalyst composition formed by the method of claim 1.

18. The method of claim 1 further comprising contacting the supported catalyst system with an olefin monomer to form a polyolefin in a process selected from gas phase process, solution phase process, slurry phase processes and combinations thereof.

19. The method of claim 1 further comprising contacting the supported catalyst system with an olefin monomer to form a polyolefin, wherein the polyolefin comprises a polymer selected from ethylene, a C₃ or greater alpha olefin, a C₄ or greater conjugated diene, an ethylene-alpha olefin copolymer or combinations thereof.

20. The method of claim 1 further comprising contacting the supported catalyst system with an olefin monomer to form a polyolefin, wherein the polyolefin is selected from polyethylene, polypropylene and combinations thereof.

21. The method of claim 1 further comprising contacting the supported catalyst system with a propylene monomer to form isotacetic polypropylene.

22. The method of claim 1 further comprising contacting the supported catalyst system with an olefin monomer to form a polyolefin comprising a molecular weight distribution selected from unimodal, bimodal or multimodal.

23. The method of claim 1 further comprising contacting the supported catalyst system with a propylene monomer to form a syndiotacetic polypropylene.

24. The method of claim 1, wherein the transition metal compound is selected from metallocene catalysts comprising a symmetry selected from C₁, Cₛ or C₂.

25. The method of claim 1, wherein the transition metal compound is selected from metallocene catalysts, late transition metal catalysts, post metallocene catalysts and combinations thereof.

26. The method of claim 1 further comprising calcining the inorganic support composition at a temperature of from about 200° C. to about 600° C. in the presence of oxygen.

27. A catalyst system comprising:
an inorganic support composition, wherein the inorganic support composition comprises a bonding sequence selected from Si—O—Al—F, F—Si—O—Al, F—Si—O—Al—F and combinations thereof; and
an organometallic catalyst compound, wherein the transition metal compound is represented by the formula [L]ₘM[A]ₙ; wherein L is a bulky ligand, A is a leaving group, M is a transition metal and m and n are such that a total ligand valency corresponds to the transition metal valency.

28. The catalyst of claim 27 further comprising a second aluminum containing compound represented by the formula AlR₃, wherein each R is independently selected from alkyls, aryls, halogens or combinations thereof.

29. The catalyst of claim 28, wherein the second aluminum containing compound comprises triisobutylaluminum.

30. The catalyst of claim 27 further comprising a weight ratio of silica to aluminum (Al¹) of from about 0.01:1 to about 1000:1 and a weight ratio of fluorine to silica of from about 0.001:1 to about 0.3:1.

31. The catalyst of claim 27 further comprising from about 0.1 wt. % to about 5 wt. % transition metal compound.

32. The catalyst of claim 27, wherein the transition metal compound is selected from metallocene catalysts, late transition metal catalysts, post metallocene catalysts and combinations thereof.
